(19) United States
(12) Patent Application Publication
(10) Pub. No.: US 2017/0071175 A1
(43) Pub. Date: Mar. 16, 2017

(54) RESIN CLOSED EYE ON A FISHING HOOK

(71) Applicant: Rapala VMC Corporation, Helsinki (FI)

(72) Inventor: Cyrille Mathieu, Chaska, MN (US)

(21) Appl. No.: 15/266,374

(22) Filed: Sep. 15, 2016

Related U.S. Application Data
(60) Provisional application No. 62/218,784, filed on Sep. 15, 2015.

(51) Int. Cl. A01K 83/00; B05D 7/14

(52) U.S. Cl. CPC A01K 83/00; B05D 7/14; B05D 2202/00

(57) ABSTRACT

A fishing hook is provided that can include a rod defining a line tie loop (having an aperture defined therein) and a resin bead sealing the line tie loop. Methods of forming such a fishing hook are also provided, which may involve applying a resin bead onto a line tie loop defined on a metal rod such that an aperture remains defined therein.

### PRIORITY INFORMATION

The present application claims priority to U.S. Provisional Patent Application Ser. No. 62/218,784 titled “Resin Closed Eye on a Fishing Hook” filed on Sep. 15, 2015, the disclosure of which is incorporated by reference herein.

### FIELD OF THE INVENTION

The present invention relates generally to fishing lures having a resin sealed eye, along with its methods of manufacture and use.

### BACKGROUND OF THE INVENTION

Sport fishing is enjoyed around the world. From fresh water to salt water, a wide variety of fish species exist. Fishermen employ a variety of equipment and tackle depending upon the water being fished, the time of day, the species of fish sought, personal choice, and many other factors. A fishing lure, sometimes referred to as an artificial lure, is frequently a part of such equipment and tackle.

A fishing lure and/or hook is generally tied to a fishing line utilizing a eye in the lure and/or on the hook. However, the eye can chaff or otherwise damage the fishing line in use, particularly when fighting a fish. As such, an improved interaction between the fishing line and eye is generally desirable.

### BRIEF DESCRIPTION OF THE INVENTION

Aspects and advantages of the invention will be set forth in part in the following description, or may be obvious from the description, or may be learned through practice of the invention.

A fishing hook is generally provided. In one embodiment, the fishing hook includes a rod defining a line tie loop (having an aperture defined therein) and a resin bead sealing the line tie loop.

Methods of forming such a fishing hook are also generally provided. In one embodiment, a resin bead is applied onto a line tie loop defined on a metal rod such that an aperture remains defined therein.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended Figs., in which:

FIG. 1 is a top side view of an exemplary fishing hook according to one embodiment; and

FIG. 2 is a top view of the resin closed eye of the exemplary fishing lure shown in FIG. 1.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

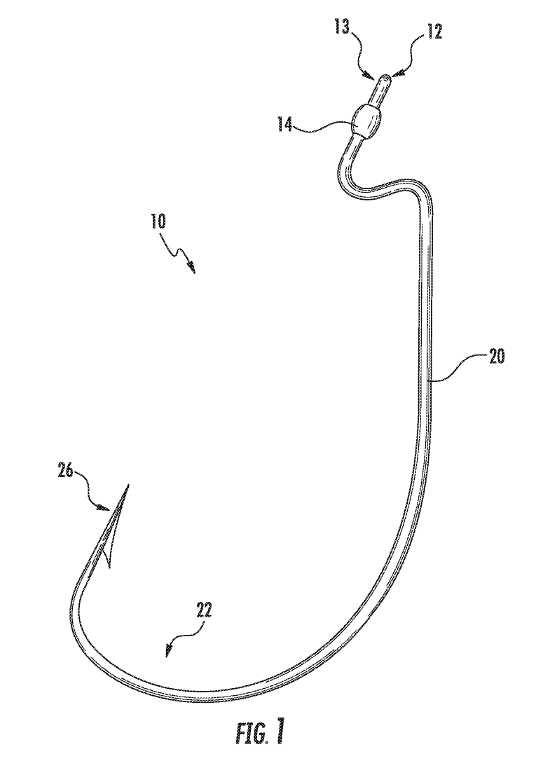

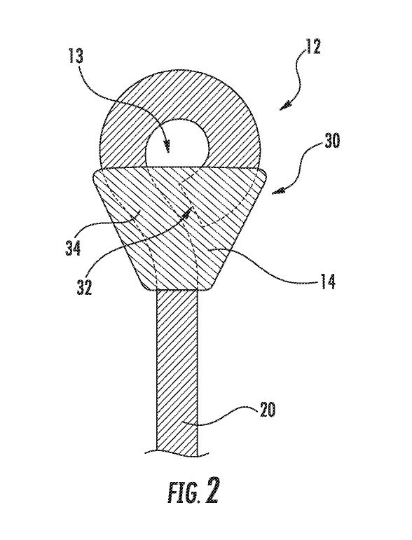

A fishing lure having a resin sealed eye is generally provided, along with its methods of manufacture and use. Referring to FIGS. 1 and 2, an exemplary fishing hook 10 is generally provided that includes a line tie loop 12 sealed with a resin bead 14. Generally, the line tie loop 12 (also referred to as an eye or eyelet of the hook) defines an aperture 13 configured to attach to a fishing line (not shown). The fishing line can be attached directly to the line tie loop 12, or to an optional ring (when present). As is known in the art, the fishing line can be connected to the line tie loop 12 or the split ring (when present) by any connection mechanism (e.g., a knot, a crimp attachment, etc.).

The fishing hook 10 is shown in the exemplary embodiments of FIG. 1 as being a single hook formed from a rod 20 and having a comprising a barbed point 24, a hook bend region 22, a hook shaft region 24, and the line tie loop 12. However, the fishing hook 10 can be any suitable hook (e.g., a mono hook, double hook, or treble hook). For example, hook 10 can be comprised of more than one hook bend 22 and/or barbed point 24, such as a double or treble hook. Also, hook 10 can take the shape of any conventional hook that is typically used while fishing. Finally, the size of hook 10 can vary according to the particular application and fish targeted.

Referring now to FIG. 2, the line tie loop 12 is formed from an end 30 of the rod 20 where the edge 32 (defined by the end 30 of the rod 22) faces a shaft portion 34 of the rod 20. The resin bead 14 at least partially covers the shaft portion 34 facing the edge 32. In certain embodiments, the resin bead 14 completely encases the edge 32 and the shaft portion 34 facing the edge 32.

As such, the combination of the rod 22 forming the line tie loop 12 and the resin bead 14 forms the aperture 13 which is completely surrounded by material, instead of defining a gap therein. The, the resin bead 14 keeps the line from chafing on the cut edge of the wire forming the line tie loop (i.e., the end of the metal hook). Additionally, the resin bead 14 keeps a relatively small diameter fishing line from working its way through the gap defined in the line tie loop at the end of the cut edge of the wire with the shaft.

The resin is generally formed from a polymeric material (i.e., a material that includes a polymer). As used herein, the term “polymer” generally includes, but is not limited to, homopolymers; copolymers, such as, for example, block, graft, random and alternating copolymers; and terpolymers; and blends and modifications thereof. Furthermore, unless otherwise specifically limited, the term “polymer” shall include all possible geometrical configurations of the material. These configurations include, but are not limited to isotactic, syndiotactic, and random symmetries.

In one embodiment, the resin bead is formed from a thermoplastic material. The term “thermoplastic” is used herein to mean any material formed from a polymer which softens and flows when heated; such a polymer may be heated and softened a number of times without suffering any basic alteration in characteristics, provided heating is below the decomposition temperature of the polymer. Examples of thermoplastic polymers include, by way of illustration only, polyolefins, polyesters, polyamides, polyurethanes, acrylic ester polymers and copolymers, polyvinyl chloride, polyvinyl acetate, etc. and copolymers thereof.

Alternatively, the line tie attachment with the resin bead can be attached to a fishing lure body, dive lip, etc.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A fishing hook, comprising:
a rod defining a line tie loop, wherein the line tie loop defines an aperture; and
a resin bead sealing the line tie loop.

2. The fishing hook as in claim 1, wherein the rod is a metal rod.

3. The fishing hook as in claim 1, wherein the resin bead comprises a polymeric material.

4. The fishing hook as in claim 1, wherein the resin bead comprises a thermoplastic material.

5. The fishing hook as in claim 1, wherein the rod has an end defining an edge at least partially covered by the resin bead.

6. The fishing hook as in claim 5, wherein the edge of the end faces a shaft portion of the rod to define the line tie loop, and wherein the resin bead at least partially covers the shaft portion facing the edge.

7. The fishing hood as in claim 1, wherein the metal rod has an end defining an edge that is encased by the resin bead.

8. The fishing hook as in claim 7, wherein the edge of the end faces a shaft portion of the rod to define the line tie loop, and wherein the resin bead encases the shaft portion at the edge.

9. The fishing hook as in claim 1, wherein the aperture is completely surrounded by material.

10. A method of making a fishing hook, comprising:
applying a resin bead onto a line tie loop defined on a metal rod such that an aperture remains defined therein.

11. The method of claim 10, wherein the rod is a metal rod.

12. The method of claim 10, wherein the resin bead comprises a polymeric material.

13. The method of claim 10, wherein the resin bead comprises a thermoplastic material.

14. The method of claim 10, wherein the rod has an end defining an edge at least partially covered by the resin bead.

15. The method of claim 14, wherein the edge of the end faces a shaft portion of the rod to define the line tie loop, and wherein the resin bead at least partially covers the shaft portion facing the edge.

16. The method of claim 16, wherein the metal rod has an end defining an edge that is encased by the resin bead.

17. The method of claim 16, wherein the edge of the end faces a shaft portion of the rod to define the line tie loop, and wherein the resin bead encases the shaft portion at the edge.

18. The method of claim 1, wherein the aperture is completely surrounded by material.
